(19) United States
(12) Patent Application Publication
(10) Pub. No.: US 2009/0052306 A1
(43) Pub. Date: Feb. 26, 2009

(54) Semiconductor Laser Generator and Method of Controlling the Same, and Optical Disk Device

(76) Inventors: Naohito Ikeda, Yokohama (JP); Koichi Watanabe, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/057,463

(22) Filed: Mar. 28, 2008

(30) Foreign Application Priority Data
Aug. 20, 2007 (JP) 2007-214124

(51) Int. Cl. G11B 7/00; H01S 3/00

(52) U.S. Cl. 369/116; 372/38.02

(57) ABSTRACT

The present invention provides a laser generator that allows recording quality to be improved, a method of controlling the laser generator, and an optical disk device. In a laser emitting device including a semiconductor laser diode emitting laser and a semiconductor laser diode driving section supplying a driving pulse to the semiconductor laser diode to drive the semiconductor laser so as to blink on the basis of the driving pulse, an impedance between the semiconductor laser diode and the semiconductor laser diode driving section is controlled to an appropriate condition.

### CROSS-REFERENCES TO RELATED APPLICATIONS

This application relates to and claims priority from Japanese Patent Application No. 2007-214124, filed on Aug. 20, 2007, the entire disclosure of which is incorporated herein by reference.

### BACKGROUND

1. Field of the Invention

The present invention relates to a semiconductor laser generator and a method of controlling the semiconductor generator, and an optical disk device, and is preferably applied to an optical disk device, for example, a CD (Compact Disc) drive, a DVD (Digital Versatile Disc) drive, and/or a BD (Blu-ray Disc) drive.

2. Description of Related Art

In recent years, optical disks have been widely used as storage media in which digital data is stored. Digital data is generally recorded on an optical disk by irradiating and heating a recording surface of the optical disk with semiconductor laser light (hereinafter referred to as laser) to form marks called recording marks on the recording surface.

In this case, inappropriately formed recording marks may prevent the recorded data from being correctly reproduced. Thus, a method has been widely used which uses pulsed laser to control heat accumulation when the recording film in the optical disk is irradiated with the laser, allowing the recording marks to be appropriately formed. In general, a semiconductor laser diode (hereinafter referred to as an LD (Laser Diode) that emits the laser can be allowed to emit the pulsed laser by supplying a pulsed current to the LD.

An apparatus that supplies the pulsed current to the LD is called a laser diode driving device (hereinafter referred to as an LDD (Laser Diode Drive). When the LDD supplies the pulsed current to the LD, the LD emits light in a light emission pattern based on the pulse timing of the supplied current. This allows the LD to emit the pulsed laser, enabling the appropriate recording marks to be formed. The pulsed current supplied to the LD by the LDD is hereinafter referred to as a recording pulse.

There has been a tendency to increase, year by year, the rate at which data is recorded on optical disks. The load of the electric circuit between the LD and LDD inherently exerts no small adverse effects; the load of the electric circuit affects a recording pulse being supplied to the LD by the LDD.

However, as the recording rate increases to reduce the pulse width of the recording pulse, the load of the electric circuit between the LD and the LDD relatively more seriously affects the recording pulse. This makes it difficult to supply the desired recording pulse to the LD. When the desired recording pulse is not supplied to the LD, the LD fails to provide the desired light emission pattern. This markedly affects the recording marks generated on the recording surface of the disk. Recording quality is thus degraded.

To solve this problem, Japanese Patent Application No. 2006-48885 focuses on a variation in the load of the electric circuit between the LD and the LDD dependent on temperature and discloses a method of acquiring information on the temperature during the use of the device or the load on the LD varying with the temperature and using the LDD to generate a recording pulse appropriately processed on the basis of the temperature. According to this application, the recording pulse processed on the basis of the temperature is supplied to the LD, which can thus emit the appropriate laser even if the temperature environment varies during the use of the device.

### SUMMARY

However, to allow the LDD to generate the recording pulse appropriately processed on the basis of the temperature, Japanese Patent Application No. 2006-48885, described above, adopts a method of generating a recording pulse to be supplied to the LD by providing the LDD with an auxiliary pulse generator which is different from a recording pulse generator normally provided in the LDD and which is used to deal with the temperature problem and synthesizing a recording pulse generated by the recording pulse generator and an auxiliary pulse generated by the auxiliary pulse generator on the basis of the temperature. That is, it is essential for the method disclosed in Japanese Patent Application No. 2006-48885 to provide the auxiliary pulse generator in the LDD.

However, in normal semiconductor laser generators, the auxiliary pulse generator is not provided in the LDD. This precludes the light emission pulse emitted by the LD from being controlled in association with a variation in the load on the LD dependent on the temperature as described above. The load on the LD is hereinafter referred to as the differential resistance of the LD.

Although Japanese Patent Application No. 2006-48885 describes that the differential resistance of the LD varies depending on the temperature, the present inventor has found through examinations that the differential resistance of the LD also varies depending on the light emission power of the LD, which varies with a temporal change, the recording rate, or the like.

Moreover, when products (for example, optical disk devices) in which the semiconductor laser generator comprising the LD and LDD as described above is mounted are mass-produced, the differential resistance of the LD is expected to vary within a certain range among the mass-produced LDs. In the above-described case, the variation in the differential resistance of the LD cannot be traced by monitoring the temperature. This prevents the light emission pulse from the LD from being controlled.

Furthermore, the configuration of common optical disk devices often includes no means for measuring the differential resistance of the LD during the use of the optical disk device. This prevents the differential resistance of the LD from being measured.

The present invention is made in view of these points. An object of the present invention is to propose a laser generator that enables recording quality to be improved using a simple configuration, a method of controlling the laser generator, and an optical disk device.

To accomplish the object, the present invention provides a laser generator comprising a semiconductor laser diode emitting laser, a semiconductor laser diode driving section supplying a driving pulse to the semiconductor laser diode to drive the semiconductor laser so as to blink on the basis of the driving pulse, and an impedance control section controlling an impedance between the semiconductor laser diode and the semiconductor laser diode driving section to an appropriate condition.

The present invention provides a method of controlling a laser emitting device comprising a semiconductor laser diode and a semiconductor laser diode driving section supplying a driving pulse to the semiconductor laser diode to drive the semiconductor laser so as to blink on the basis of the driving pulse, the method comprising controlling an impedance between the semiconductor laser diode and the semiconductor laser diode driving section to an appropriate condition.

The present invention further provides an optical disk device irradiating an optical disk with laser to record and/or reproduce data, the optical disk device comprising the laser emitting device.

The present invention is expected to increase a recording margin and a temperature margin using the simple configuration, allowing recording quality to be improved. May use the “means of solving the invention” section of Japanese Application.

Other aspects and advantages of the invention will be apparent from the following description and the appended claims.

### BRIEF DESCRIPTION OF THE DRAWINGS

FIG. 1 is a block diagram showing the entire configuration of an optical disk device according to the present embodiment;

FIG. 2 is a block diagram showing the configuration of a general laser generator;

FIG. 3(A) is a waveform diagram showing a recording pulse waveform, and FIGS. 3(B) to 3(D) are waveform diagrams showing the waveform of a light emission pulse observed with the condition of the impedance between an LD and an LDD varied;

FIG. 4 is a graph showing the relationship between a voltage to be applied to the LDD and an output impedance of the LDD;

FIG. 5 is a graph showing the relationship between the differential resistance of the LD and the appropriate voltage to be applied to the LDD;

FIG. 6 is a block diagram showing the configuration of a laser generating section of an optical disk device according to the present embodiment;

FIG. 7 is a characteristic curve diagram showing the relationship between a voltage value set for a voltage source and the rise time of a light emission pulse and the magnitude of overshoot;

FIG. 8 is a conceptual diagram showing the configuration of a voltage source control table according to a first embodiment;

FIG. 9 is a flowchart showing the process procedure of a power supply voltage setting control process according to the first embodiment;

FIG. 10 is a graph showing temporal changes in the differential resistance of the LD;

FIG. 11 is a flowchart showing the process procedure of a temporal change countermeasure process according to the first embodiment;

FIG. 12 is a graph showing the relationship between laser power and the differential resistance of the LD;

FIG. 13 is a flowchart showing the process procedure of a laser power change countermeasure process;

FIG. 14 is a graph showing the relationship between temperature and the differential resistance of the LD;

FIG. 15 is a flowchart showing the process procedure of a temperature change countermeasure process;

FIG. 16 is a graph illustrating the impedance of an LD-LDD connection line connecting the LDD and the LD together;

FIG. 17 is a graph showing the relationship between the differential resistance of the LD and the line width of the LD-LDD connection line;

FIG. 18 is a conceptual diagram showing a first voltage source control table according to a second embodiment:

FIG. 19 is a flowchart showing the process procedure of a power supply voltage setting control process according to the second embodiment;

FIG. 20 is a conceptual diagram showing a second voltage source control table according to the second embodiment; and

FIG. 21 is a flowchart showing the process procedure of a first voltage source control table updating process.

### DETAILED DESCRIPTION OF PREFERRED EMBODIMENTS

Embodiments of the present invention will be described below with reference to the drawings.

### (1) First Embodiment

(1-1) Configuration of the Optical Disk Device According to the Present Embodiment

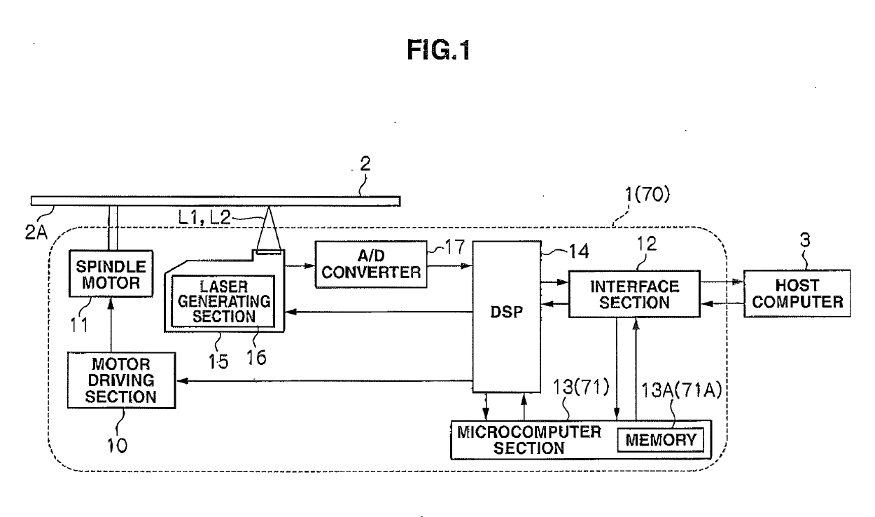

FIG. 1 shows an optical disk device 1 according to the present embodiment. The optical disk device 1 is compatible with an optical disk 2 such as a BD, a DVD, or a CD. In response to a request from a host computer 3, the optical disk device 1 can record data on the optical disk 2 or reproduce the data recorded on the optical disk 2.

In the optical disk device 1, under the control of a digital signal processor 14, a motor driving section 10 drives a spindle motor 11 to rotate the optical disk 2 installed in a predetermined condition, in a rotating condition in accordance with a recording scheme for the optical disk 2 (for example, a CAV (Constant Angular Velocity) scheme or a CLV (Constant Linear Velocity) scheme).

In the optical disk device 1, various commands transmitted by the host computer 3 are provided to a microcomputer section 13 via an interface section 12.

The microcomputer section 13 comprises a memory 13A in which control programs are stored. The microcomputer section 13 executes control processes or arithmetic processes in accordance with the commands provided by the host computer 3 and various pieces of information provided by a digital signal processor 14.

For example, if the host computer 3 provides a recording command to the microcomputer section 13, the microcomputer section 13 controls the interface section 12 such that data to be recorded subsequently provided by the host computer 3 is transmitted to the digital signal processor 14.

The digital signal processor 14 executes a predetermined signal process including a modulating process on the data to be recorded provided via the interface section 12. The digital signal processor 14 transmits the recording signal obtained to a laser generating section 16 of an optical pickup 15.

The laser generating section 16 comprises an LDD and an LD. The LDD in the laser generating section 16 drives the LD so as to blink on the basis of the recording signal provided by the digital signal processor. As a result, the LD emits laser L1 spatially modulated on the basis of the recording signal. The laser L1 is condensed on a recording surface 2A of the optical disk 2 via a focus lens (not shown) in the optical pickup 15. Thus, the data to be recorded is recorded on the optical disk 2.

Reflection light L2 from the optical disk 2 receiving the laser L1 is photoelectrically converted by a photodetector (not shown) in the optical pickup 15. An RF (Radio Frequency) signal resulting from the photoelectric conversion is then converted into a digital signal by an analog/digital converting section 17. The resultant digital RF signal is provided to the digital signal processor 14.

On the basis of a supplied digital RF signal, the digital signal processor 14 generates various control signals such as a focus error signal, a tracking error signal, and a rotation control signal. Thus, on the basis of the focus error signal and the tracking error signal, a biaxial actuator (not shown) in the optical pickup 16 is controlled to enable focus control and tracking control. Furthermore, the rotation control signal is provided to the motor driving section 10, which controllably rotates the spindle motor 11 on the basis of the rotation control signal.

Moreover, part of the laser L1 emitted by the LD in the optical pickup 15 is dispersed before entering the focus lens and photoelectrically converted by an APC (Auto Power Control) photodetector (not shown) in the optical pickup 16. Furthermore, an RF signal obtained by the photoelectric conversion is converted into a digital signal by the analog/digital converting section 17. The resulting digital RF signal is provided to the digital signal processor 14.

Thus, the digital signal processor 14 controls the signal level of a driving signal dispatched to the laser driving section 15 such that laser power has a target value preset for APC.

On the other hand, upon receiving a reproduction command from the host computer 3 via the interface section 12, the microcomputer section 13 controls the digital signal processor 14 such that the digital signal processor 14 dispatches a predetermined control signal to the laser generating section 16 in the optical pickup.

On the basis of the supplied control signal, the laser generating section 16 drives the LD so as to light in the optical pickup 15 at a predetermined voltage. As a result, the LD emits the laser L1 of predetermined power, which is condensed on the recording surface 2A of the optical disk 2 via the focus lens described above.

The reflection light L2 from the optical disk 2 receiving the laser L1 is photoelectrically converted by the photodetector in the optical pickup 15. The RF signal resulting from the photoelectric conversion is then converted into a digital signal by the analog/digital converting section 17. The resultant digital RF signal is provided to the digital signal processor 14.

The digital signal processor 14 executes a reproduction signal process such as a demodulating process on the supplied digital RF signal to obtain reproduced data. The digital signal processor 14 then dispatches the data obtained to the host computer 3 via the interface section 12.

As is the case with the data recording, the digital signal processor 14 generates various control signals such as the focus error signal, the tracking error signal, and the rotation control signal on the basis of the digital RF signal. Thus, as is the case with the data recording, the focus control, the tracking control, and the rotation control of the spindle motor 11 are performed on the basis of the focus error signal, the tracking error signal, and the rotation control signal.

(1-2). Method of Controlling a LD Light Emission Pulse According to the Present Embodiment

Now, description will be given of a method of controlling a light emission pulse emitted by the LD in the optical disk device 1.

(1-2-1) Principle

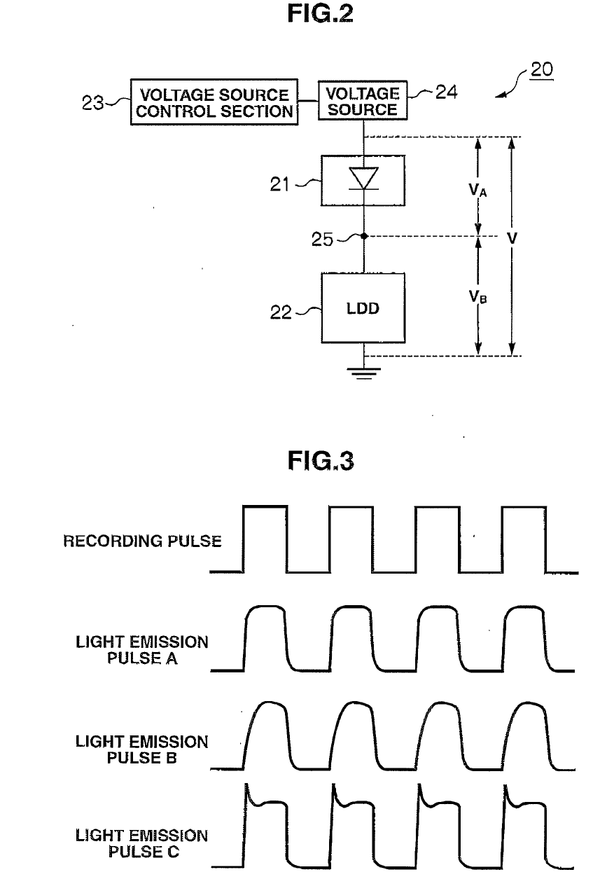

FIG. 2 shows the configuration of a common laser generator 20. The laser generator 20 is composed of an LD 21 and an LDD 22 which are connected in series. An output voltage from a voltage source 24 having a set voltage value V controlled by a voltage source control section 23 is applied to the LD 21. The laser generator 20 supplies a recording pulse generated in the LDD 22 to the LD 21 via a current driving amplifier (not shown) in the LDD 22. Thus, on the basis of the driving voltage supplied by the voltage source 24, the LD 21 emits the laser L1 spatially modulated on the basis of the recording pulse from the LDD 22.

FIG. 3 shows the relationship between the pulse waveform (FIG. 3(A) of the recording pulse output by the LDD 22 and the pulse waveform (FIGS. 3(B) to 3(D) of a light emission pulse emitted by the LD 22 when the output impedance of the LDD 22 is varied to vary the condition of the impedance between the LD 21 and the LDD 22. FIG. 3(B) shows the pulse waveform of the light emission pulse obtained when the impedance between the LD 21 and the LDD 22 is set to an appropriate condition. In this case, the recording pulse output by the LDD 22 does not substantially lose shape.

FIG. 3(C) shows the pulse waveform of the light emission pulse obtained when the output impedance of the LDD 22 is lower than that in FIG. 3(B). If the relationship for the impedance between the LD 21 and the LDD 22 is inappropriate, the light emission pulse loses shape. In this case, the output impedance of the LDD 22 is low, a delay occurs in the rise time and fall time of the pulse waveform of the recording pulse output by the LDD 22. FIG. 3(D) shows the pulse waveform of the light emission pulse obtained when the output impedance of the LDD 22 is higher than in FIG. 3(B). In this case, overshoot occurs when the light emission pulse rises, preventing the light emission pulse from being shaped as desired.

This indicates that setting the impedance between the LD 21 and the LDD 22 to the appropriate condition is important in allowing the LD 21 to emit light while preventing the recording pulse from losing shape.

Thus, the optical disk device 1 according to the present embodiment sets the impedance between the LD 21 and the LDD 22 to the appropriate condition on the basis of the differential resistance of the LD 21 to prevent the recording pulse output by the LDD 22 from being degraded before the pulse reaches the LD 21.

To accomplish this, the optical disk device 1 uses a method of controlling a voltage V_{B} to be applied to the LDD 22 (this method is hereinafter referred to as a first LD light emission pulse control method) and a method of creating a line which connects the LD 21 and the LDD 22 together and which is in a predetermined condition (this method is hereinafter referred to as a second LD light emission pulse control method). The first and second LD light emission pulse control methods are effective even when each of the methods is independently applied. However, higher effects can be exerted by simultaneously applying the two methods than by independently applying each method.

(1-2-2) First LD Light Emission Pulse Control Method

(1-2-2-1) Contents of the First LD Light Emission Pulse Control Method

First, the first LD light emission pulse control method will be described. In FIG. 2, when a voltage to be applied to the LD 21 (hereinafter referred to as the voltage to be applied to the LD 21) is defined as V_{A}, and a voltage to be applied to the LDD 22 (the voltage of a connection middle point 25; hereinafter referred to as the voltage to be applied to the LDD 22) is defined as V_{B}, a set voltage value V for the voltage source 24 can be approximated as follows;

V=V_{A}+V_{B} (1)

Thus, the voltage source control section 23 varies the set voltage value V for the voltage source 24 to enable the voltage of the connection middle point 25 to be varied.

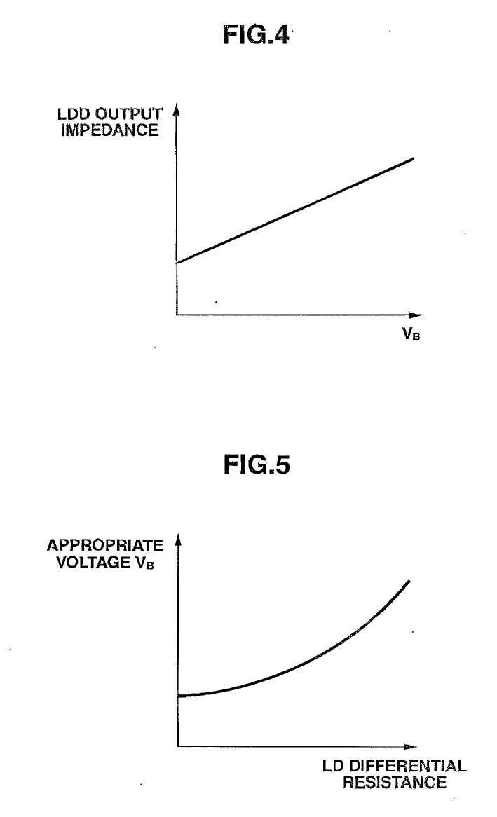

In this case, the voltage of the connection middle point 25 is the voltage V_{B} to be applied to the LDD 22. A variation in the voltage V_{B} to be applied varies the output impedance of the LDD 22. FIG. 4 shows the relationship between the voltage V_{B} to be applied to the LDD 22 and the output impedance of the LDD 22. Thus, Formula (1) and the relationship between the voltage V_{B} to be applied to LDD 22 and the output impedance of the LDD 22, shown in FIG. 4, indicate that when the voltage V_{A} to be applied to the LD 21 does not vary, varying the set voltage value V for the voltage source 24 enables the output impedance of the LDD 22 to be varied.

In this case, varying the output impedance of the LDD 22 varies the impedance relationship between the LD 21 and the LDD 22. Consequently, controlling the set voltage value V for the voltage source 24 makes it possible to control the impedance relationship between the LD 21 and the LDD 22. Thus, the set voltage value V for the voltage source 24 is varied and set the output impedance of the LDD 22 to an appropriate value corresponding to the differential resistance of the LD 21. This allows the LD 21 to emit laser while preventing the recording pulse from losing shape.

Furthermore, if the LDD 22 is composed of a MOS (Metal Oxide Semiconductor)-based transistor, then the LDD 22 undergoes a more significant variation in output impedance with respect to the voltage V_{B} to be applied to the LDD 22 (the voltage of the connection middle point 25) than the LDD 22 composed of a bipolar transistor. It is thus particularly effective to use the method of varying the set voltage value V for the voltage source 24 to vary the output impedance of the LDD 22 as described above.

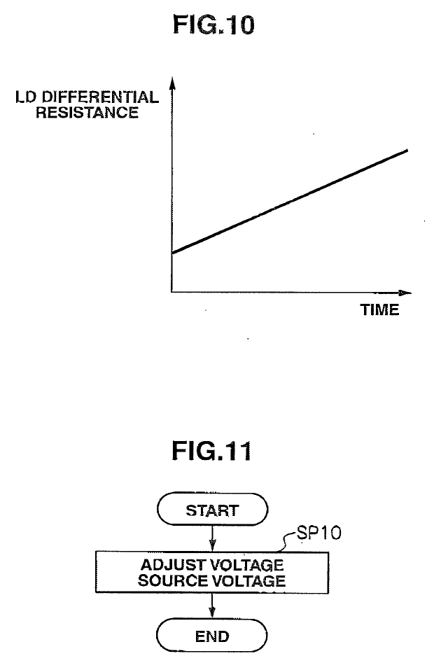

However, the differential resistance of the LD 21 varies depending on the temperature and laser power used, temporal changes, and the individual variability of the LD 21 as described above. FIGS. 10, 12, and 14 show the relationship between these factors and the differential resistance of the LD 21. As shown in FIG. 5, a variation in the differential resistance of the LD 21 varies the voltage V_{B} to be applied to the LDD 22 in order to keep the impedance between the LD 21 and the LDD 22 in the appropriate condition (that is, the appropriate voltage V_{B} to be applied to the LDD 22). Thus, to deal with a variation in environment during the use of the LD 21, it is necessary to acquire information on the differential resistance of the LD 21 and control the set voltage value V for the voltage source 24 to the appropriate value on the basis of the information.

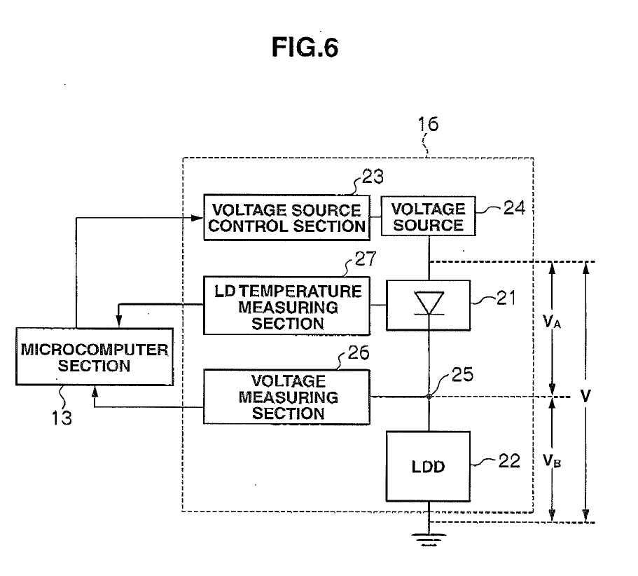

Thus, in the optical disk device 1, as shown in FIG. 6 where components corresponding to those in FIG. 2 are denoted by the same reference numerals, the laser generating section 16 of the optical pickup 15 (FIG. 1) has a voltage measuring section 26 that measures the voltage of the connection middle point 25 (the voltage V_{B} to be applied to the LDD 22). The set voltage value V for the voltage source 24 is controlled on the basis of the voltage value of the connection middle point 25, measured by the voltage measuring section 26.

The relationship between the value of the differential resistance of the LD 21 and the appropriate voltage V_{B} to be applied to the LDD 22, shown in FIG. 5, and the relationship between a variation in use environment of the LD 21 and the differential resistance, shown in FIGS. 10, 12, and 14, the appropriate voltage V_{TRG} of the connection middle point 25 which deals with the environment in which the LD 21 is used (that is, the appropriate voltage V_{B} to be applied to the LDD 22; hereinafter referred to as the appropriate voltage V_{TRG}) can be determined. Thus, in the present embodiment, the set voltage value V for the voltage source 24 is controlled such that the voltage of the connection middle point 25 becomes equal to the appropriate voltage V_{TAG}.

In FIG. 6, the voltage measuring section 26 is located outside the LDD 22. However, the voltage measuring section 26 may be installed inside the LDD 22 provided that the voltage measuring section 26 can measure potentials equivalent to that of the connection middle point 25. The connection middle point 25 may be located anywhere on the line connecting the LD 21 and the LDD 22 together.

In this case, the relationship between the environment in which the LD 21 is used and the appropriate voltage V_{B} to be applied to the LDD 22 can be preset by examining the relationship between the differential resistance of the LD 21 and the appropriate voltage V_{B} to be applied to the LDD 22. Description will be given below of a method of examining the relationship between the differential resistance of the LD 21 and the appropriate voltage V_{B} to be applied to the LDD 22.

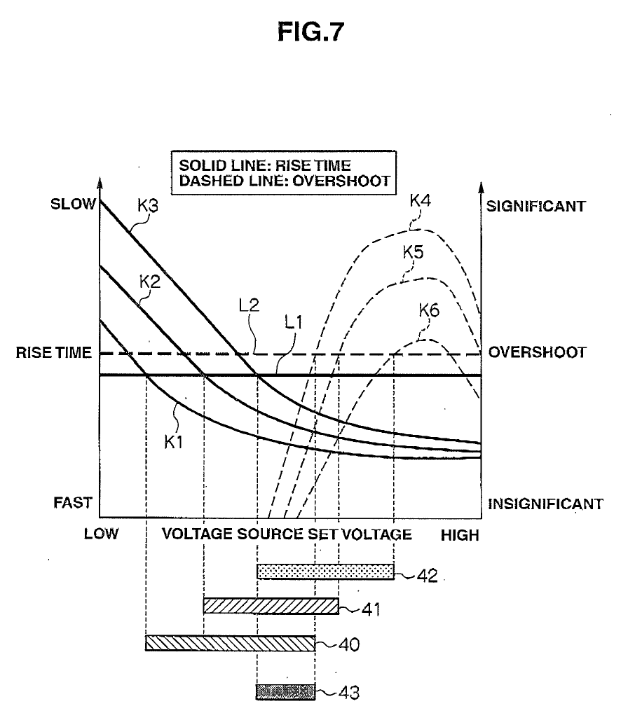

FIG. 7 shows the relationship between the rise time of a light emission pulse from the LD 21 and the voltage V_{B} to be applied to the LDD 22 and the relationship between the overshoot characteristic of the light emission pulse from the LD 21 and the voltage V_{B} to be applied to the LDD 22; the relationships have been acquired by varying the differential resistance of the LD 21 among three values. In FIG. 7, solid lines show the rise time characteristic of the light emission pulse. A curve K1 shows the lowest differential resistance of the LD 21. A curve K2 shows the second lowest differential resistance of the LD 21. A curve K3 shows the highest differential resistance of the LD 21. Dashed lines show the overshoot characteristic. A curve K4 shows the lowest differential resistance of the LD 21. A curve K5 shows the second lowest differential resistance of the LD 21. A curve K6 shows the highest differential resistance of the LD 21.

Preventing the light emission pulse from the LD 21 from losing shape is the purpose of controlling the set voltage value V for the voltage source 24 such that the voltage of the connection middle point 25 becomes equal to the appropriate voltage V_{TAG}. It is thus necessary to determine the voltage V_{B} to be applied to the LDD 22 in the configuration shown in FIG. 6 such that the rise time of the light emission pulse from the LD 21 is shorter than a specified level and such that the magnitude of overshoot is smaller than a specified level. Reference numeral L1 denotes a line showing a tolerance limit on the rise time of the light emission pulse. If the value of the rise time is smaller than the value indicated by the line L1, the light emission pulse from the LD 21 can be kept in the desired pulse waveform. Similarly, Reference numeral L2 denotes a line showing a tolerance limit on the magnitude of the overshoot. If the magnitude of the overshoot is smaller than the value indicated by the line L2, the light emission pulse from the LD 21 can be kept in the desired pulse waveform. That is, the appropriate voltage V_{TAG} is the voltage V_{B} to be applied which meets both conditions.

For example, if the differential resistance of the LD 21 is low, the range of the appropriate voltage V_{TAG} is shown by a bar 40. If the differential resistance of the LD 21 is high, the range of the appropriate voltage V_{TAG} is shown by a bar 42. The set voltage value V for the voltage source 24 is appropriate when the voltage value of the connection middle point 25 measured by the voltage measuring section 26 is within a range 43 in which the above-described ranges overlap. Thus, the relationship between the differential resistance of the LD 21 and the voltage to be applied to the LDD 22 can be determined by examining the shape of the light emission pulse from the LD 21 while varying the value of the differential resistance of the LD 21. A combination of this relationship with the relationship between the use environment of the LD 21 and the differential resistance, shown in FIGS. 10, 12 and 14, makes it possible to preset the relationship between the use environment of the LD 21 and the appropriate voltage V_{B} to be applied to the LDD 22. By adjusting the set voltage value V for the voltage source 24 on the basis of this relationship, it is possible to obtain a light emission pulse of the ideal pulse waveform.

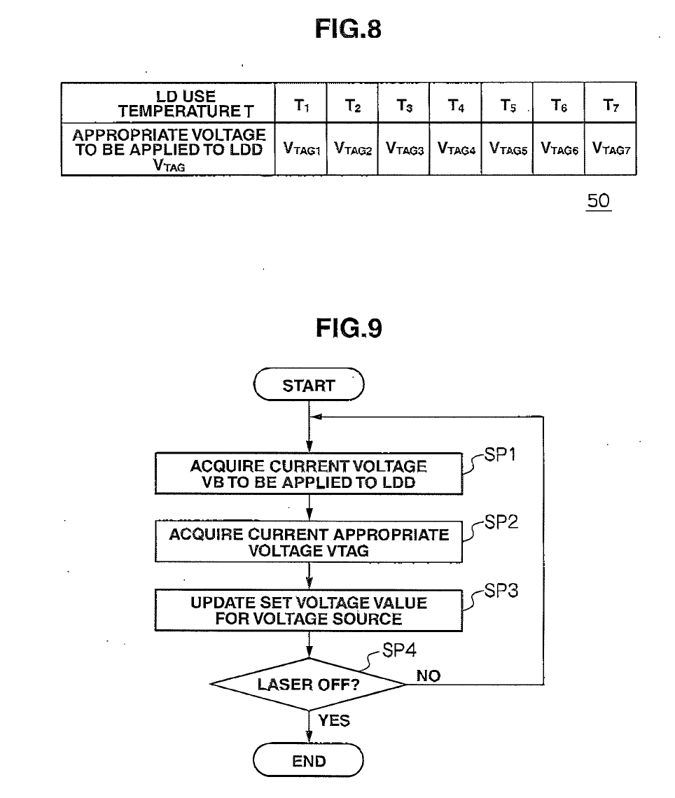

Thus, the optical disk device 1 according to the present embodiment holds, for example, a memory 13A (FIG. 1) in the microcomputer section 13 as a voltage source control table 50 as shown in FIG. 8, in which the relationship between the use environment of the LD 21 and the appropriate voltage V₅ to be applied to the LDD 22 is associated with the current use environment of the LD 21 and the voltage V_{TAG} for the connection middle point 25 which is appropriate for the environment. The microcomputer section 13 appropriately adjusts the set voltage value V for the voltage source 24 in association with the use environment of the optical disk device 1 utilizing the voltage source control table 50 and the measurement of the voltage of the connection middle point 25 provided by the voltage measuring section 26 of the laser light emitting section 16. This enables the output impedance of the LDD 22 to be adjusted, making it possible to controllably prevent the light emission pulse from the laser L1 from losing shape.

FIG. 8 shows an example in which only the temperature environment is taken into account by way of example. However, the voltage source control table 50 that can deal with main factors varying the differential resistance of the LD 21 can be created by also taking laser power and temporal changes into account. The voltage source control table 50 may be in any form provided that the table 50 associates the use environment of the optical disk device 1 and the voltage set value V for the voltage source 24. The table may be held as a relational expression for the use environment of the LD 21 and the voltage V_{B} to be applied to the LDD 22 which is appropriate for the environment. However, as shown in FIG. 7, if the voltage V_{B} (appropriate voltage V_{TA}) to be applied to the LDD 22 can take a somewhat wide range of values and does not require any detailed settings, holding the table as in the case of the present embodiment enables the omission of calculation processes and a reduction in the number of times that voltage adjustment described below is performed. This in turn enables a reduction in loads on the microcomputer section 13. Furthermore, when the table associates the current use environment of the LD 21 with the set voltage value V for the voltage source 24, required to set the voltage of the connection middle point 25 to the appropriate value V_{TAG}, as shown in FIG. 8, the voltage set value V for the voltage source 24 can be easily controlled.

Now, description will be given of a procedure used in the optical disk device 1 according to the present embodiment to appropriately set the condition of the impedance between the LD 21 and the LDD 22 utilizing the measurement from the voltage measuring section 26 and the voltage source control table 50.

FIG. 9 shows the specific contents of a process executed by the microcomputer section 13 in association with the control of the voltage set value V for the voltage source 24, described above. The microcomputer section 13 executes a power supply voltage setting control process shown in FIG. 9, in accordance with a corresponding control program stored in the memory 13A.

For every driving of the LD 21, the microcomputer section 13 starts the voltage source setting voltage value control process. First, the microcomputer section 13 acquires the current voltage of the connection middle point 25 measured by the voltage measuring section 26 (SP1).

Subsequently, the microcomputer section 13 acquires from the voltage source control table 50 the voltage V_{TAG} of the connection middle point 25 which is appropriate for the current use environment of the LD 21 (the current appropriate voltage V_{B} to be applied to the LDD 22) (SP2).

Then, the microcomputer section 13 calculates the difference between the appropriate voltage V_{TAG} and the current voltage of the connection middle point 25 acquired in step SP1. The microcomputer section 13 then controls the voltage source control section 23 such that the difference becomes “0” or takes a value close to “0”, to update the set voltage value V for the voltage source 24 (SP3).

The microcomputer section 13 subsequently determines whether or not to turn off the laser L1 (whether or not all the recording data has been written) (SP4). Upon making a negative determination, the microcomputer section 13 returns to step SP1 to repeats a loop from step SP1 to step SP4 until the microcomputer section 13 makes an affirmative determination in step SP4. As a result, the voltage of the connection middle point 25 converges to the appropriate value V_{TRG} (the voltage V_{B} applied to the LDD 22 converges to the appropriate value).

Upon making an affirmative determination in step SP4, the microcomputer section 13 ends the voltage source setting voltage value control process.

(1-2-2-2) Function for Improving the Performance of the Optical Disk Device

(1-2-2-2-1) Various Functions Mounted in Optical Disk Device

By adjusting the set voltage value V for the voltage source 24 every time the laser L1 is emitted during the use of the LD 21 as described above, it is possible to keep the impedance between the LD 21 and the LDD 22 in the appropriate condition according to the use environment of the LD 21.

However, the temporal performance of the optical disk device 1 may be important depending on the use purpose of the optical disk device 1. The temporal performance of the optical disk device 1 may be degraded by, for every use of the LD 21, determining the use environment and adjusting and setting the set voltage value V for the voltage source 24. This problem can be solved by reducing the number of times that the set voltage value V for the voltage source 24 is adjusted and set.

For example, the range of the set voltage value V for the voltage source 24 required to allow the LD 21 to emit the appropriate light pulse is expected to have a certain amount of margin. That is, even if the use environment such as the temperature at which the LD 21 is used or the laser power varies slightly during the use of the LD 21) the laser can be emitted with the appropriate light emission pulse provided that the set voltage value V for the voltage source 24 within the margin. For example, in FIG. 7, as seen in the overlapping range between the bars 40 and 41, even when the differential resistance of the LD 21 has different values, a voltage set value V is present which is appropriate for both differential resistances.

Thus, in order to reduce the number of times that the set voltage value V for the voltage source 24 is adjusted and set, the adjustment and setting may be performed only when the use environment is changed. Moreover, the adjustment and setting may be performed only when the degree of the change in environment is such that the change cannot be dealt with by the current set voltage value V for the voltage source 24.

Although the differential resistance of the LD 21 varies depending on the use environment as described above, major factors varying the use environment and thus the differential resistance have been found to be temporal changes in LD 21, the laser power, and the use temperature.

That is, the set voltage value for the voltage source 24 may be adjusted and re-set only when any of the values for these factors varies and the variation is so significant that the current voltage set value V for the voltage source 24 needs to be changed.

To accomplish this, information on these factors during the use of the device needs to be acquired. Description will be given of a method of acquiring information on these factors and timings for adjusting and setting the set voltage value V for the voltage source 24.

(1-2-2-2-2) Countermeasures for Temporal Changes

The term “temporal change in LD 21” as used herein refers to a change in the differential resistance of the LD 21 resulting from the use of the LD 21 if the LD 21 has been used or left for a long period. The long period refers to at least one day. Thus, the differential resistance value normally remains unchanged during the time required to record data all over the surface of the optical disk 2 using optical disk device 1 (FIG. 1).

As shown in FIG. 10, the temporal change tends to increase the differential resistance of the LD 21. The increase in the differential resistance of the LD 21 corresponds to generation of the voltage V_{B} to be applied to the LD 21. Thus, by checking the voltage of the connection middle point 25 at least once when the laser L1 is emitted during the use of the optical disk device 1, it is possible to acquire temporal change information on the basis of the set voltage value V for the voltage source 24 and Formula (1). Consequently, the temporal change can be dealt with by acquiring the temporal change information during the use of the optical disk device 1 and then adjusting the set voltage value V for the voltage source 24 at least once.

FIG. 11 is a flowchart showing the specific contents of a process executed by the microcomputer section 13 to deal with a variation in the differential resistance of the LD 21 caused by the temporal change as described above. The microcomputer section 13 executes a temporal change countermeasure process shown in FIG. 11 in accordance with the corresponding control program stored in the memory 13A.

That is, when the optical disk device 1 is powered on, the microcomputer section 13 starts the temporal change countermeasure process and acquires the current voltage of the connection middle point 25 from the voltage measuring section 26 to update the set voltage value V for the voltage source 24 as required on the basis of the acquired voltage (SP10). Specifically, the microcomputer section 13 executes steps SP1 to SP4 of the voltage source set voltage value control process, described above with reference to FIG. 9, to update the set voltage value V for the voltage source 24 to the appropriate value for the current use environment of the LD 21. The microcomputer section 13 then ends the temporal change countermeasure process.

(1-2-2-2-3) Countermeasure for a Change in Laser Power

The power of the laser L1 depends on the amount of current in the recording pulse supplied to the LD 21 by the LDD 22. The recording pulse generated by the LDD 22 is based on recording data provided to the LDD 22. The recording data to be input to the LDD 22 is generated by the digital signal processor 14 and provided to the LDD 22 by the digital signal processor 14 at a timing when the light emission pattern of laser 1205 is to be changed.

Thus, the microcomputer 13, which controls the digital signal processor 14, knows the timing when the laser power changes during the use of the optical disk device 1. Consequently, the microcomputer section 13 may controls the digital signal processor 14 at the timing when the power of the laser L1 is to be changed, to adjust and set the set voltage value V for the voltage source 24

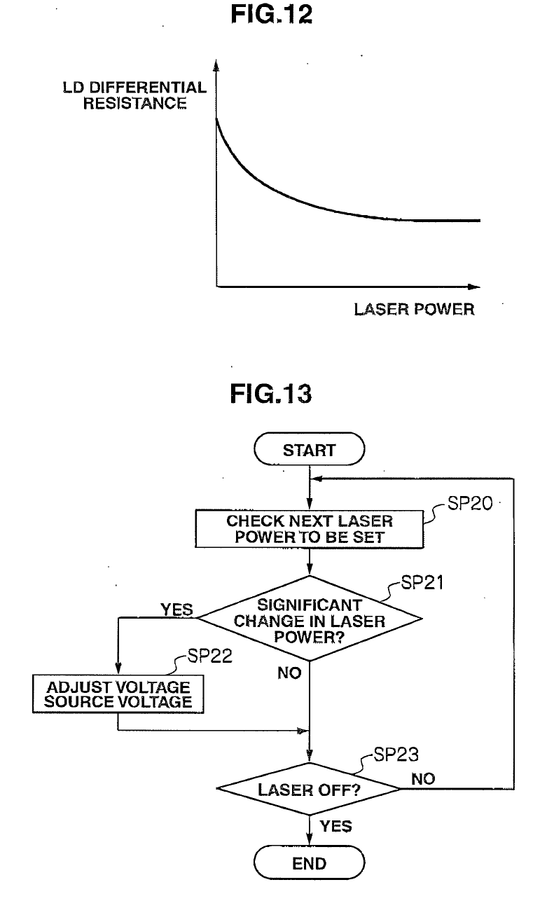

Moreover, since such a relationship as shown in FIG. 12 has been found to exist between the laser power and the differential resistance of the LD 21. Thus, when the laser power is to be changed but the difference between the original laser power and the changer laser power is small and if the amount of variation in the differential resistance of the LD 21 is small enough to keep the set voltage value V within the appropriate voltage range without the need for a change in the value V, the temporal performance of the optical disk device 1 can be improved by avoiding adjusting and setting the set voltage value V.

Here, FIG. 13 is a flowchart showing the specific contents of a process executed by the microcomputer section 13 to deal with a variation of the differential resistance of the LD 21 caused by the change in laser power as described above. The microcomputer section 13 executes a laser power change countermeasure process shown in FIG. 13, in accordance with the corresponding control program stored in the memory 13A.

That is, in the optical disk device 1 according to the present embodiment, to change the laser power, the microcomputer section 13 checks the next laser power value to be set at the timing when the laser power is to be changed (SP20).

The microcomputer section 13 subsequently determines whether or not the difference between the changed laser power set value and the original laser power set value is greater than a preset threshold (SP21). Upon making a negative determination, the microcomputer section 13 proceeds to step SP23. In contrast, upon making an affirmative determination, the microcomputer section 13 executes steps SP1 to SP3 of the voltage source set voltage value control process, described with reference to the relevant figure, to update the set voltage value V for the voltage source 24 to the appropriate value for the current laser power (SP22).

The microcomputer section 13 then determines whether or not the laser has been turned off (whether or not the data recording has been completed) (SP23). Upon making a negative determination, the microcomputer section 13 returns to step SP20 to repeat the processing in steps SP20 to SP23 until the microcomputer section 13 makes an affirmative determination in step SP23. Upon making an affirmative determination in step S23, the microcomputer section 13 ends the laser power change countermeasure process.

(1-2-2-2-4) Countermeasure for a Change in Use Temperature

The use temperature of the LD 21 can be measured by providing the laser generating section 16 with an LD temperature measuring section 27 that measures the temperature of the LD 21 or the vicinity thereof, as shown in FIG. 6.

When the set voltage value V for the voltage source 24 is initially set, the temperature of the LD 21 observed is measured by the LD temperature measuring section 27. The measured temperature is stored to the optical disk device 1. Subsequently, the temperature of the LD 21 is periodically acquired from the LD temperature measuring section 27. If the difference between the acquired temperature and the stored temperature exceeds a specified value, the set voltage value V for the voltage source 24 may be adjusted.

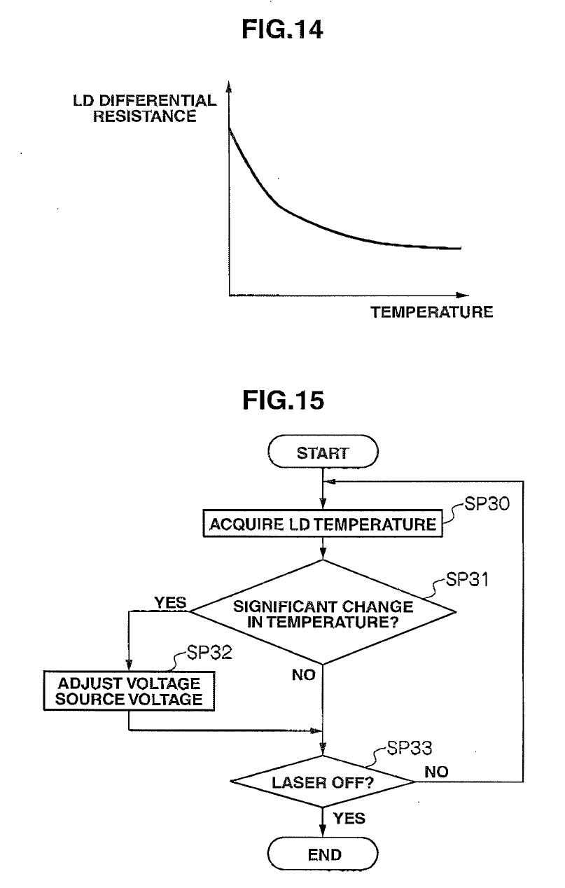

On the basis of a characteristic shown in FIG. 14, how the differential resistance of the LD 21 changes can be determined by measuring the temperature when the set voltage value V for the voltage source 24 is set and measuring the current temperature. Thus, for example, an upper limit may be set for the difference value of the differential resistance. Then, the set voltage value V for the voltage source 24 may be adjusted when the temperature difference is such that the preset differential resistance difference value is exceeded by the difference between the value of the differential resistance of the LD 21 obtained at the temperature measured when the set voltage value V for the voltage source 24 is set and the value of the differential resistance of the LD 21 obtained at the current temperature.

FIG. 15 is a flowchart showing the specific contents of a process executed by the microcomputer section 13 to deal with a variation in the differential resistance of the LD 21 caused by the change in use temperature as described above. The microcomputer section 13 executes a use temperature change countermeasure process shown in FIG. 15, in accordance with the corresponding control program stored in the memory 13A.

That is, when the laser L1 is turned on, the microcomputer section 13 starts the temperature change countermeasure process. First, the microcomputer section 13 acquires the measurement of the current temperature of the LD 21 from the LD temperature measuring section 27 (SP30).

The microcomputer section 13 subsequently determines whether or not the difference between the temperature measured when the set voltage value V for the voltage source 24 is set and the current temperature of the LD 21 exceeds a preset threshold (SP31). Upon making a negative determination, the microcomputer section 13 proceeds to step SP33. In contrast, upon making an affirmative determination, the microcomputer section 13 executes steps SP1 to SP3 of the voltage source set voltage value control process, described with reference to FIG. 9, to update the set voltage value V for the voltage source 24 to the appropriate value for the current temperature of the LD 21.

The microcomputer section 13 then determines whether or not the laser L1 has been turned off (whether or not the data recording has been completed) (SP33). Upon making a negative determination, the microcomputer section 13 returns to step SP30 to repeat the processing in steps SP30 to SP33. Upon making an affirmative determination in step S33, the microcomputer section 13 ends the temperature change countermeasure process.

(1-2-3) Second LD Light Emission Pulse Control Method

Now, a second LD light emission pulse control method will be described. The above-described first LD light emission pulse control method adjusts the set voltage value V for the voltage source 24 depending on a variation in differential resistance associated with the use environment of the LD 21 in order to set the impedance between the LD 21 and the LDD 22 to the appropriate condition.

However, for example, the setting range of the set voltage value V for the voltage source 24 may be limited, precluding the impedance between the LD 21 and the LDD 22 from being set to the appropriate condition even by adjusting the set voltage value V for the voltage source 24.

To deal with this, in view of the settable range of the set voltage value V for the voltage source 24, preparations need to be made for adjustments such that the impedance between the LD 21 and the LDD 22 can be set to the appropriate condition simply by adjusting the set voltage value V for the voltage source 24.

Thus, for the optical disk device 1, the second LD light emission pulse control method appropriately adjusts the impedance of the line electrically connecting the LD 21 and the LDD 22 (this line is hereinafter referred to as the LD-LDD line) according to the relationship between the output impedance of the LDD 22 and the impedance of the LD 21. This makes it possible to preset the impedance between the LD 21 and the LDD 22 close to the appropriate condition.

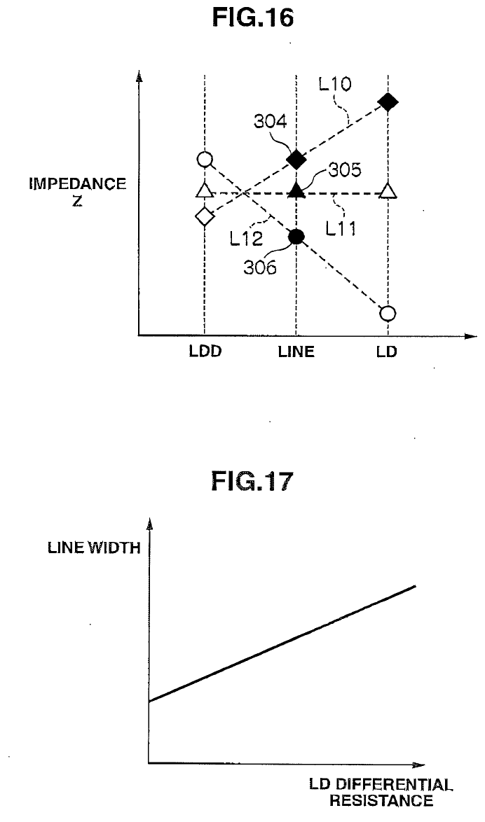

FIG. 16 shows an example. In FIG. 16, the axis of ordinate shows the magnitude of the impedance, and the items on the axis of abscissa include the LDD 22, the LD-LDD line, and the LD 21. The impedance of the LD 21 has a value varying depending on the differential resistance of the LD 21. When the impedance and the differential resistance are defined as Z and Rd, respectively, and reactance and conductance are defined as L and C, respectively, the impedance of the LD 21 can be expressed as follows:

$$Z = Rd + \sqrt{\frac{L}{C}} \qquad ( 2 )$$

FIG. 16 shows three relationships between the impedance of the LD 21 and the impedance of the LDD 22 (a straight line L10, a straight line L11, and a straight line L12). In FIG. 16, for each of the relationships, a value close to the average value of the impedances of the LD 21 and the LDD 22 are determined to be the impedance of the LD-LDD line. A mark “♦” 304, a mark “▴” 305, and a mark “” 306 are plotted at positions corresponding to these values. By thus setting the impedance of the LD-LDD line equal to the intermediate value of the impedances of the LD 21 and the LDD 22, it is possible to set the impedance between the LD 21 and the LDD 22 to the appropriate condition.

An example of a method of varying the impedance of the LD-LDD line is to change the line width of the LD-LDD line. This enables the impedance of the LD-LDD line to be changed. If the impedance is changed by changing the line width of the LD-LDD line, then since the appropriate line width varies depends on the differential resistance of the LD 21, for example, as shown in FIG. 17, an LD-LDD line with a line width appropriate for the differential resistance may be used to connect the LD 21 and the LDD 22 together provided that the differential resistance of the LD 21 is known. This makes it possible to set the impedance between the LD 21 and the LDD 22 to the appropriate condition.

Even in the optical disk device 1 according to the present embodiment, if the laser light emitting section 16 has a margin for the appropriate impedance condition, the line width of the LD-LDD line need not be strictly adjusted. Thus, for example, LDs 21 are roughly classified into two types, one with a higher differential resistance and the other with a lower differential resistance. An LD-LDD line with a smaller line width is applied to the former, whereas an LD-LDD line with a larger line width is applied to the latter.

In the present embodiment, the impedance of the LB-LDD line is changed by changing the line width by way of example. Other methods are widely applicable provided that the method can change the impedance of the LD-LDD line.

The first and second LD light emission pulse control methods have been described. However, a configuration adopting the first and second LD light emission pulse control methods as shown in FIG. 6 is effectively applied as the laser generating section 16 of the optical pickup 15. This is because the effects of both the first and second LD light emission pulse control methods facilitates the maintenance of the impedance between the LD 21 and the LDD 22 in the appropriate condition.

### (2) Second Embodiment

(2-1) Method of Adjusting the Set Voltage Value for the Voltage Source According to the First Embodiment

As described above, determining the factor varying the differential resistance of the LD 21 allows the set voltage value V for the voltage source 24 to be efficiently adjusted and set.

However, the method according to the first embodiment adjusts the set voltage value V for the voltage source 24 when the temperature varies by an amount equal to or greater than a specified value during the use of the LD 21 or when the laser power is to be significantly changed. In this case, if for example, data is being recorded on the optical disk 2 (FIG. 1), the data recording is stopped before the voltage for the voltage source 24 is adjusted.

Furthermore, to adjust the set voltage value V for the voltage source 24, the laser L1 is emitted during the adjustment. The optical pickup 15 (FIG. 1) may need to be moved, during the adjustment, to an area of the optical disk 2 which may be irradiated with the laser L1 without posing any problem, or the optical pickup 15 may need to be moved and changed from an in-focus condition to an out-of-focus condition to prevent the laser L1 from focusing on the recording surface of the optical disk 2.

Thus, if the method of adjusting the set voltage value V for the voltage source 24 according to the first embodiment is performed, the method requires the time for the actual adjustment, the period of preparations for the adjustment, and the time required to return to the unadjusted condition. This may degrade the temporal performance of the optical disk device.

Thus, in the second embodiment, description will be given of a method of controlling the set voltage value V for the voltage source 24 while preventing the temporal performance of the optical disk device from being degraded as described above. The method described below is an example in which a system is provided for which improvements are made in the method of adjusting and setting the set voltage value V for the voltage source 24 according to the first embodiment and in the timing for performing the adjustment and setting and for which the temporal performance of the optical disk device is taken into account.

(2-2) Method of Adjusting the Set Voltage Value for the Voltage Source According to the Present Embodiment

For example, if the following are known: the temperature of the LD 21 measured by the LD temperature measuring section 27 of the laser generating section 16, described above with reference to FIG. 6, and the voltage to be set for the voltage source 24 (to-be-set voltage value V) according to the laser power to be set, then the set voltage value V for the voltage source 24 need not be adjusted. In this case, the set voltage value V for the voltage source 24 has only to be changed to the desired value.

In the present embodiment, the voltage source control table 50 (FIG. 8) is modified such that the set voltage value for the voltage source 24 can be selected on the basis of two pieces of information, that is, the laser power and the use temperature of the LD 21, which are the major factors varying the differential resistance of the LD 21. Adjustment is performed only once during the use to deal with a temporal variation in the differential resistance of the LD 21.

Experimentally determining the relationships in FIGS. 10 and 12 enables the creation of the table allowing the set voltage value V for the voltage source 24 to be determined on the basis of the relationship between the differential resistance of the LD 21 and both the laser power and the use environment of the LD 21, using the input two pieces of information, the laser power and the use temperature of the LD 21.

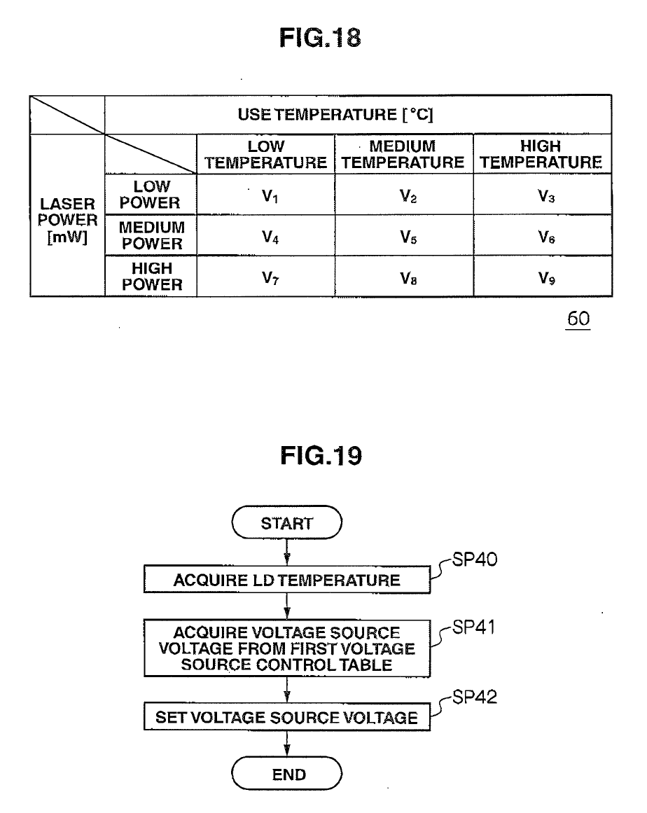

The present embodiment pre-creates the voltage source control table which receives the laser power and the use temperature of the LD 21 as inputs and which outputs the set voltage value V for the voltage source 24. FIG. 18 shows a first voltage source control table 60 according to the present embodiment.

In the first voltage source control table 60, the laser power is classified into three levels, “low power”, “medium power”, and “high power”. The use temperature of the LD 21 is also classified into three levels, “low temperature”, “medium temperature”, and “high temperature”. Set voltage values V (V₁ to V₉) to be set for the voltage source 24 are specified in association with combination patterns of the laser power and the use temperature of the LD 21.

The first power source control table 60 may be used to acquire the laser power and the use temperature of the LD 21 during the use of the optical disk device. If the resulting combination pattern of the laser power and the use temperature of the LD 21 is different from the last one, the set voltage value V for the voltage source 24 may be changed so as to correspond to the current combination pattern. The first voltage source control table 60 allows the omission of the adjustment of the set voltage value V for the voltage source 24 depending on a change in use environment.

As described above, the set voltage value V for the voltage source 24 which is appropriate for a certain use environment has a certain margin. Thus, the use environment may be roughly classified as is the case with the present embodiment without the need to precisely set the set voltage value V for the voltage source 24. Of course, the number of appropriate combination patterns of the laser power and the use environment of the LD 21 varies depending on the appropriate voltage margin for the voltage source 24. Consequently, the number of combination patterns may be set to any value. Setting a large number of combination patterns of the laser power and the use temperature of the LD 21 enables the set voltage value V for the voltage source 24 to be precisely controlled. This is thus effective if the voltage source 24 has a narrow appropriate voltage range.

Furthermore, if the appropriate range of the set voltage value V for the voltage source 24 is wide, it is possible to roughly control the set voltage value V for the voltage source 24 without increasing the number of combination patterns of the laser power and the use temperature of the LD 21. This enables a reduction in the number of times that the voltage for the voltage source 24 is set, providing a system that takes the temporal performance of the optical disk device into account.

For the laser power, it is more effective to use different combination patterns of the laser power and the use temperature of the LD 21 for laser power for data recording and for laser power for data reproduction. As a basis for this, the combination patterns can be distinguished from one another because the laser power for the data reproduction is lower than that for the data recording.

The laser light emission for reproduction need not record data and does not provide pulsed light emission for data recording. Thus, during data reproduction, the LDD 22 does not supply the LD 21 with such a recording pulse as provided for data recording. This eliminates the need to be very conscious of the condition of the impedance between the LD 21 and the LDD 22. Consequently, the set voltage value V for the voltage source 24 may be relatively freely set. In this case, setting the set voltage value V for the voltage source 24 to as small a value as possible reduces the power consumption of the optical disk device.

Furthermore, a high frequency component may be added to the laser emitted for data reproduction in order to prevent possible laser noise. In this case, the voltage value for the voltage source 24 may need to be set differently from that for data recording so as to prevent the added high frequency component from being deformed and to optimize the condition of the impedance between the LD 21 and the LDD 22. In this case, it is also effective to set different zones for reproduction and for recording to use different set voltage values V for the voltage source 24, for reproduction and for recording.

The first voltage source control table 60 is in the form of a table that contains fixed set voltage values V for the voltage source 24 for the respective combination patterns of the laser power and the use temperature of the LD 21. However, the first voltage source control table 60 may be in the form of a calculating formula expressing the relationship between the appropriate voltage for the voltage source 24 and both the use temperature of the LD 21 and the laser power.

FIG. 19 is a flowchart showing the contents of a process executed by a microcomputer section 71 (FIG. 1) to control the voltage set value V for the voltage source 24 utilizing the first voltage source control table 60 in an optical disk device 70 (FIG. 1) according to the second embodiment. The microcomputer section 71 executes a power supply voltage setting control process according to the second embodiment shown in FIG. 19, in accordance with the corresponding control program stored in the memory 71A (FIG. 1).

That is, the microcomputer section 71 starts the temperature change countermeasure process in recording or reproducing data to or from the optical disk 2. First, the microcomputer section 71 acquires the measurement of the current temperature of the LD 21 from the LD temperature measuring section 27 (SP40).

The microcomputer section 71 subsequently reads the corresponding set voltage value from the first voltage source control table 60 on the basis of the current temperature of the LD 12 acquired in step SP30 and the laser power set depending on the current recording rate (SP41).

The microcomputer section 71 controls the voltage source control section 23 to set the set voltage value V for the voltage source 24 to the set voltage value read from the first voltage source control table 60 (SP42). The microcomputer section 71 subsequently ends the power supply voltage setting control process.

(2-3) Countermeasures for Temporal Changes

The first voltage source control table 60, described above with reference to FIG. 18, is based on the relationship between the laser power and the use temperature of the LD 21. Thus, the temporal change in LD 21 can be dealt with simply by acquiring information on the differential resistance of the LD 21 at least once during the use of the optical disk device 70. Updating the voltage source control table 60 on the basis of the information allows the creation of the first voltage source control table 60 that deals with the temporal change during the use. Description will be given, by way of example of a method of creating the first voltage source control table 60 that deals with the temporal change.

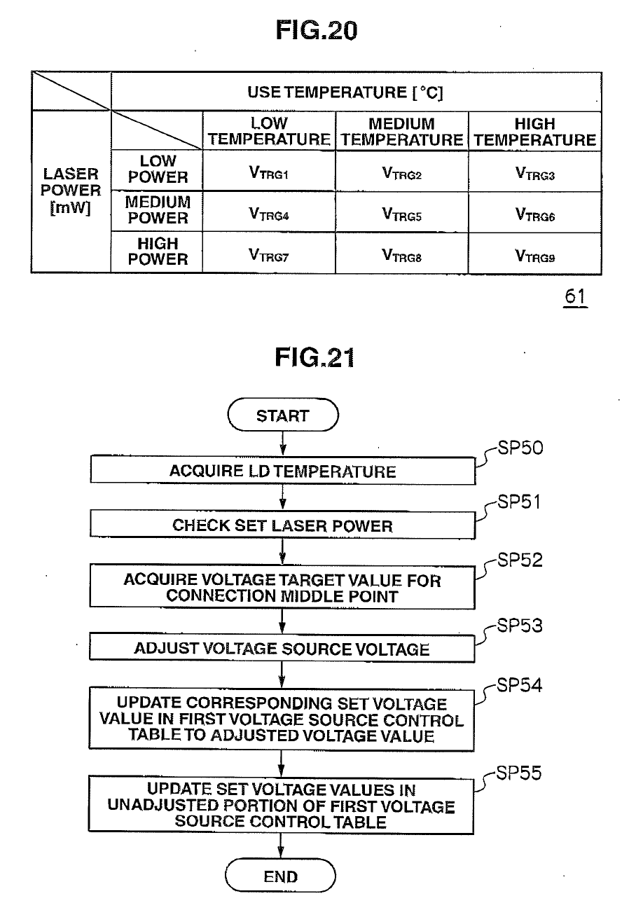

The first voltage source control table 60 allows the appropriate set voltage value for the voltage source 24 to be acquired from the laser power and the use temperature of the LD 21. In the present embodiment, besides the first voltage source control table 60, a second voltage source control table 61 as shown in FIG. 20 is provided which has the same configuration as that of the first voltage source control table 60 and which allows the appropriate voltage of the connection middle point 25 between the LD 21 and the LDD 22 in FIG. 6 to be acquired from the laser power and the use temperature of the LD 21.

During the use of the optical disk device 70 according to the second embodiment, the set voltage value V for the voltage source 24 is adjusted at least once. The adjustment is performed such that the set voltage value V for the voltage source 24 is varied so as to set the voltage measured by the voltage measuring section 26 equal to a target value that is the voltage of the connection middle point 25 acquired in association with the combination pattern of the laser power and the use temperature of the LD 21 during the adjustment on the basis of FIG. 18. The set voltage value V for the voltage source 24 resulting from the adjustment is registered as the set voltage value V for the voltage source 24 corresponding to the combination pattern of the laser power and the use temperature of the LD 21 in the first voltage source control table 60. Furthermore, the set voltage values V for the voltage source 24 not corresponding to the combination pattern in the first voltage source control table 60 used for the adjustment can also be calculated even though these set voltage values V for the voltage source 24 correspond to the combination patterns that are not actually used for the adjustment. This is because the tendencies of the voltage values corresponding to the respective combination patterns in the first voltage source control table 60 are known,

For example, it is assumed that the set voltage value V for the voltage source 24 is adjusted for a high temperature and high power. In this case, the set voltage value V for the voltage source 24 is adjusted such that the voltage of the connection middle point 25 is set to V_{TRG3} in the second voltage source control table 61 in FIG. 19. Here, the adjusted set voltage value V for the voltage source 24 is defined as V_{ANS}. Then, V_{ANS} may be registered at V₃ in the first voltage source control table 60.

For the combination pattern not actually used for the adjustment, for example, the combination pattern of high temperature and medium power, since the first voltage source control table 60 indicates the relationship between V₃ and V₆, the value can be calculated, by way of example, on the basis of the difference between V₃ and V₆ by adding V_{ANS} to the value of the difference between V₃ and V₆. Thus, the set voltage values V for the voltage source 24 corresponding to the combination patterns not actually used for the adjustment can be registered in the first voltage source control table 60. This enables the creation of the first voltage source control table 60 that deals with temporal changes.

FIG. 21 is a flowchart showing the specific contents of a process executed by the microcomputer section 71 to create the first voltage source control table 60 that deals with the temporal change as described above. The microcomputer section 71 executes a first voltage source control table updating process shown in FIG. 21, in accordance with the corresponding control program stored in the memory 71A (FIG. 1).

That is, upon starting the first voltage source control table updating process, the microcomputer section 71 first acquires the current temperature of the LD 21 from the LD temperature measuring section 27 (FIG. 6) (SP50). The microcomputer section 71 further checks the current set value for the laser power (SP51).

The microcomputer section 71 subsequently acquires the voltage target value for the connection middle point 25 from the second voltage source control table 61 on the basis of the temperature of the LD 21 acquired in step SP50 and the set value for the laser power determined in step SP51 (SP52).

The microcomputer section 71 subsequently adjusts the set voltage value V for the voltage source 24 via the voltage source control section 23 so that the voltage of the connection middle point 25 measured by the voltage measuring section 26 becomes equal to the voltage target value acquired in step SP52 (SP53).

The microcomputer section 71 further updates the set voltage value V (V₁ to V₉) corresponding to the temperature of the LD 21 acquired from the first voltage source control table 60 in step SP50 and the set value for the laser power determined in step SP51, to the set voltage value V adjusted in step SP53 (SP54).

The microcomputer section 71 subsequently updates the other set voltage values V (V₁ to V₉) in the first voltage source control table 60 on the basis of the relationship with the set voltage value V adjusted in step S54 (SP55). The microcomputer section 71 then ends the first voltage source control table updating process.

(2-4) Adjustment Performance Trigger

The adjustment as described above may be performed at any time. However, in view of the temporal performance of the optical disk device, it is effective to perform the adjustment, for example, as a trigger for a process of loading the optical disk 2 (FIG. 1) during the use of the optical disk device 60. The process of loading the optical disk 2 refers to the process of enabling data to be reproduced or recorded from or on the optical disk 2 after the optical disk 2 is installed in the optical disk device 60, that is, various adjustment processes of enabling data reproduction or recording.

In this case, the laser L1, emitted by the optical pickup 15, may not focus on the optical disk 2. Even if the laser of the laser power for data recording is emitted, utilizing this out-of-focus condition prevents data from being recorded on the optical disk 2 or prevents recorded data from being overwritten. The voltage for the voltage source 24 can thus be safely adjusted.

In contrast, if the adjustment process is executed after the loading process, the laser L1, emitted by the optical pickup 15, is moved so as to scan grooves in the optical disk 2 and is thus often in the in-focus condition. Thus, for the adjustment, the optical pickup 15 may be controlled to cancel the in-focus condition of the optical disk 2 before the adjustment, or if the in-focus condition is not to be canceled, the optical pickup 15 may be moved to an area of the optical disk 2 on which data may be recorded by the laser L1 being adjusted, without posing any problem.

In the above-described example, the different laser powers are used for data recording and for data reproduction. However, since the data recording and the data reproduction are controlled by the microcomputer section 13, any other method may be used to distinguish the recording from the reproduction.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A laser generator comprising:
a semiconductor laser diode emitting laser;
a semiconductor laser diode driving section supplying a driving pulse to the semiconductor laser diode to drive the semiconductor laser so as to blink on the basis of the driving pulse; and
an impedance control section controlling an impedance between the semiconductor laser diode and the semiconductor laser diode driving section to an appropriate condition.

2. The laser generator according to claim 1, further comprising a voltage source connected in series with the semiconductor laser diode and the semiconductor laser diode driving section to supply a driving voltage to the semiconductor laser diode and the semiconductor laser diode driving section,
the impedance control section controlling a set voltage value for the voltage source to control the impedance between the semiconductor laser diode and the semiconductor laser diode driving section to an appropriate condition.

3. The laser generator according to claim 2, further comprising a voltage measuring section measuring a voltage of a connection middle point between the semiconductor laser diode and the semiconductor laser diode driving section,
the impedance control section controlling the set voltage value for the voltage source on the basis of a measurement result from the voltage measuring section.

4. The laser generator according to claim 2, further comprising a temperature measuring section measuring a temperature of the semiconductor laser diode or a temperature of the vicinity of the semiconductor laser diode,
the impedance control section controlling the set voltage value for the voltage source on the basis of a measurement result from the temperature measuring section.

5. The laser generator according to claim 2, wherein the impedance control section controls the set voltage value for the voltage source on the basis of power of laser emitted by the semiconductor laser diode.

6. The laser generator according to claim 2, further comprising the voltage measuring section measuring the voltage of the connection middle point between the semiconductor laser diode and the semiconductor laser diode driving section; and
the temperature measuring section measuring the temperature of the semiconductor laser diode or the temperature of the vicinity of the semiconductor laser diode,
the impedance control section controlling the set voltage value for the voltage source on the basis of at least one of the measurement result from the voltage measuring section, a measurement result from the temperature measuring section, and the power of the laser emitted by the semiconductor laser diode.

7. The laser generator according to claim 6, further comprising a table in which a voltage value to be set for the voltage source is stored in association with at least one of the voltage of the connection middle point between the semiconductor laser diode and the semiconductor laser diode driving section, the temperature of the semiconductor laser diode or the temperature of the vicinity of the semiconductor laser diode, and the power of the laser emitted by the semiconductor laser diode,
the impedance control section controlling the set voltage value for the voltage source on the basis of the table and the corresponding measurement result from the voltage measuring section, the corresponding measurement result from the temperature measuring section, and/or the corresponding power of the laser emitted by the semiconductor laser diode.

8. The laser generator according to claim 7, wherein the impedance control section updates a content of the table according to a use environment of the semiconductor laser diode.

9. The laser generator according to claim 1, wherein an impedance of a line connecting the semiconductor laser diode and the semiconductor laser diode driving section together is adjusted so as to set the impedance between the semiconductor laser diode and the semiconductor laser diode driving section to be an appropriate condition.

10. A method of controlling a laser emitting device comprising a semiconductor laser diode and a semiconductor laser diode driving section supplying a driving pulse to the semiconductor laser diode to drive the semiconductor laser so as to blink on the basis of the driving pulse, the method comprising:
controlling an impedance between the semiconductor laser diode and the semiconductor laser diode driving section to an appropriate condition.

11. An optical disk device irradiating an optical disk with laser to record and/or reproduce data, the optical disk device comprising the laser emitting device according to claim 1.

12. The optical disk device according to claim 11, wherein the content of the table is updated at least once including a timing when the optical disk is loaded.
